(19) United States
(12) Patent Application Publication
(10) Pub. No.: US 2023/0312959 A1
(43) Pub. Date: Oct. 5, 2023

(54) Ink Jet Ink Composition And Recording Method

(71) Applicant: SEIKO EPSON CORPORATION, Tokyo (JP)

(72) Inventors: Hiroaki KIDA, Shiojiri (JP); Shintaro ASAI, Matsumoto (JP)

(21) Appl. No.: 18/191,976

(22) Filed: Mar. 29, 2023

(30) Foreign Application Priority Data
Mar. 30, 2022 (JP) 2022-055733

(51) Int. Cl. C09D 11/322; C09C 3/08; B41J 2/01

(52) U.S. Cl. CPC C09D 11/322; C09C 3/08; B41J 2/01; C08K 2201/003; C08K 9/04

(57) ABSTRACT

Provided is an ink jet ink composition which is a solvent-based ink, the composition including a metal pigment, a polyoxyalkylene amine compound, and an organic solvent, in which the metal pigment is a metal particle having a surface treated with a surface treatment agent, the surface treatment agent is a compound represented by Formula (1) or Formula (2), the polyoxyalkylene amine compound includes a compound represented by Formula (3), and the compound represented by Formula (3) is formed such that an average of m/(m+n)×100 (%) is 20% or greater.

(R¹—)P(O)(OH)₂ (1)

(R²—O—)ₐP(O)(OH)₃₋ₐ (2)

(In Formulae (1) and (2), R¹ and R² each independently represent a hydrocarbon group having 14 or more carbon atoms which may be substituted with a substituent, and a represents 1 or 2.)

R³(OC₂H₄)ₘ—(OC₃H₆)ₙ—NH₂ (3)

(In Formula (3), R³ represents a hydrogen atom or an alkyl group having 4 or more carbon atoms, m represents an integer of 1 or greater, n represents an integer of 0 or greater, and m+n is an integer of 10 or greater, where an arrangement order of an oxyethylene unit (OC₂H₄) and an oxypropylene unit (OC₃H₆) is optional.)

The present application is based on, and claims priority from JP Application Serial Number 2022-055733, filed Mar. 30, 2022, the disclosure of which is hereby incorporated by reference herein in its entirety.

### BACKGROUND

### 1. Technical Field

The present disclosure relates to an ink jet ink composition and a recording method.

### 2. Related Art

In the related art, a composition such as an ink or a coating material containing a metal pigment such as aluminum has been developed to produce a product having metallic glossiness. For example, JP-A-2019-172862 discloses a metallic ink formed of an aluminum pigment. The aluminum pigment disclosed in JP-A-2019-172862 has a surface treated with a fluorine-based treatment agent.

However, in an ink jet ink composition containing a metal pigment, the dispersion stability of the metal pigment and the lustrousness of an image to be obtained are still problems. Further, when the surface of the metal pigment is treated, oxidation of the metal pigment may progress during the treatment, and there is also a problem in that the gloss is degraded and aggregation of the metal pigment is likely to occur.

Therefore, there has been a demand for an ink jet ink composition that enables a metal pigment to have satisfactory dispersion stability and enables a recorded material with excellent metallic gloss to be obtained.

### SUMMARY

According to an aspect of the present disclosure, there is provided an ink jet ink composition which is a solvent-based ink, the composition including a metal pigment, a polyoxyalkylene amine compound, and an organic solvent, in which the metal pigment is a metal particle having a surface treated with a surface treatment agent, the surface treatment agent is a compound represented by Formula (1) or Formula (2), the polyoxyalkylene amine compound includes a compound represented by Formula (3), and the compound represented by Formula (3) is formed such that an average of m/(m+n)×100(%) is 20% or greater.

(R¹—)P(O)(OH)₂ (1)

(R²—O—)ₐP(O)(OH)₃₋ₐ (2)

(In Formulae (1) and (2), R¹ and R² each independently represent a hydrocarbon group having 14 or more carbon atoms which may be substituted with a substituent, and a represents 1 or 2.)

R³(OC₂H₄)ₘ—(OC₃H₆)ₙ—NH₂ (3)

(In Formula (3), R³ represents a hydrogen atom or an alkyl group having 4 or less carbon atoms, m represents an integer of 1 or greater, n represents an integer of 0 or greater, and m+n is an integer of 10 or greater, where an arrangement order of an oxyethylene unit (OC₂H₄) and an oxypropylene unit (OC₃H₆) is optional.)

According to another aspect of the present disclosure, there is provided a recording method including making the ink jet ink composition described above adhere to a recording medium.

### BRIEF DESCRIPTION OF THE DRAWING

FIG. 1s a schematic cross-sectional view schematically showing a recording device.

### DESCRIPTION OF EXEMPLARY EMBODIMENTS

Hereinafter, embodiments of the present disclosure will be described. The embodiments below will describe examples of the present disclosure. The present disclosure is not limited to the embodiments below and includes various modifications made in a range not departing from the scope of the present disclosure. Further, not all the configurations described below are necessarily essential configurations of the present disclosure.

In the present specification, “(meth)acryl” denotes acryl or methacryl, and “(meth)acrylate” denotes acrylate or methacrylate. Further, “ink jet ink composition” will also be referred to as “composition”, and the ink jet ink composition will also be referred to as “ink composition” or “ink”.

### 1. Ink Jet Ink Composition

An ink jet ink composition according to the present embodiment is an organic solvent-based ink jet ink composition and contains a metal pigment, a polyoxyalkylene amine compound, and an organic solvent.

### 1.1. Metal Pigment

The metal pigment is a metal particle having a surface treated with a surface treatment agent. More specifically, the metal pigment may be formed such that the surface treatment agent adheres to the surface of the metal particle via a chemical bond or through physical adsorption.

### 1.1.1. Metal Particle

The metal particle is a particle in which at least a part of a site that is visually recognized is formed of a metal material and, for example, the entirety or the vicinity of the outer surface is formed of a metal material. The metal particle has a function of applying metallic gloss in a recorded material to be produced by using an ink jet ink composition.

The metal particle is not limited as long as a region including the vicinity of the surface is formed of a metal material, and for example, the entire metal particle may be formed of a metal material or the metal particle may include a base portion formed of a non-metal material, and a coating film that covers the base portion and is formed of a metal material. Further, a passivation film such as an oxide coating film may be formed on the surface of the metal particle. Problems of water resistance, metallic glossiness, and the like have occurred in the related art even with such a metal particle, but effects of excellent water resistance, excellent metallic glossiness, and the like can be obtained by applying the ink jet ink composition of the present embodiment.

As the metal material constituting the metal particle, a single metal, various alloys, or the like can be used. Examples thereof include aluminum, silver, gold, platinum, nickel, chromium, tin, zinc, indium, titanium, iron, copper, and alloys having at least one or more of these metals. Among these metals, the metal particle is formed of preferably aluminum or an aluminum alloy and more preferably aluminum. One of the reasons why aluminum and an aluminum alloy are preferable is that the specific gravity of aluminum and an aluminum alloy is lower than the specific gravity of other metals such as iron. In this manner, since sedimentation of the metal pigment dispersed in the ink extremely slowly proceeds, the ink composition can be stored for a longer period of time while occurrence of density unevenness or the like is effectively suppressed. Further, the glossiness and the high-quality appearance of the recorded material can be improved while an increase in production cost of the recorded material produced by using the ink jet ink composition is suppressed when a metal pigment formed of the metal particle of aluminum or an aluminum alloy is used.

Aluminum and aluminum alloys originally exhibit excellent glossiness in various metal materials, but the following problems may occur when particles formed of such materials are applied to the composition. That is, the storage stability (water resistance) of the composition is likely to be decreased, and problems such as a decrease in jetting stability due to an increase in viscosity caused by gelation are likely to occur when the composition is used as an ink jet ink composition. On the contrary, even in a case where the metal pigment is formed of metal particles consisting of aluminum or an aluminum alloy, such problems can be made less likely to occur when the surface of the particle is subjected to a surface treatment with a specific surface treatment agent described below according to the present embodiment. That is, the effects of the composition of the present embodiment are more remarkably exhibited when the metal particles consist of aluminum or an aluminum alloy.

The metal particles may have any of a spherical shape, a spindle shape, a needle shape, or the like, but it is preferable that the metal particles have a scaly shape. In this manner, the main surfaces of the metal particles are easily arranged on an object, to which the composition is applied, such that the main surfaces are along the surface shape of the object. As a result, the glossiness and the like that the metal material constituting the metal particles has can be more effectively exhibited even in a recorded material to be obtained, and the glossiness and the high-quality appearance of the recorded material can be improved. Further, the rub resistance of the recorded material can also be improved when the metal particles have a scaly shape.

In the present specification, the scaly shape is, for example, a shape in which the area in plan view when the metal particles are observed at a predetermined angle is greater than the area when the metal particles are observed at an angle orthogonal to the observation direction, such as a flat plate shape or a curved plate shape.

Particularly, a ratio S₁/S₀ of an area S₁ [μm²] when the metal particles are observed in a direction in which the projected area is maximized, that is, in plan view to an area S₀ [μm²] when the metal particles are observed in a direction in which the area when observed is maximized in the direction orthogonal to the observation direction is preferably 2 or greater, more preferably 5 or greater, still more preferably 8 or greater, even still more preferably 10 or greater, even still more preferably 20 or greater, and even still more preferably 30 or greater. The upper limit of the ratio S₁/S₀ is not particularly limited, but is preferably 1000 or less, more preferably 500 or less, still more preferably 100 or less, and even still more preferably 80 or less.

As this value, for example, an average value of values obtained by observing any 50 particles and performing calculation on these particles can be employed. The observation can be performed by using an electron microscope, an atomic force microscope, or the like. Further, as another method, the volume average particle diameter (D50) and the average thickness described below are used, the units thereof are combined, and the volume average particle diameter (D50)/average thickness may be set to be in the above-described ranges.

When the metal particles have a scaly shape, the average thickness of the metal particles is preferably 5 nm or greater and 90 nm or less. The lower limit of the average thickness of the metal particles is not particularly limited, but is more preferably 10 nm or greater and still more preferably 15 nm or greater. Further, when the metal particles have a scaly shape, the upper limit of the average thickness of the metal particles is not particularly limited, but is more preferably 70 nm or less, still more preferably 50 nm or less, particularly preferably 30 nm or less, more particularly preferably 20 nm or less, and still more particularly preferably 15 nm or less.

When the metal particles have a scaly shape and the average thickness thereof is 5 nm or greater and 90 nm or less and preferably in the above-described ranges, the effects obtained in a case where the particles as described above have a scaly shape are likely to be more remarkably exhibited.

In addition, the average thickness of the metal particles can be measured by using an atomic force microscope (AFM) in the same manner as that for the average thickness of the metal pigment described below. For example, the average thickness is defined as an average value obtained by measuring any 50 metal particles using atomic force microscopy. That is, the average thickness is an arithmetic average thickness.

The preferable ranges and the measuring method of the volume average particle diameter (D50) of the metal particles can be set to be the same as those for the volume average particle diameter (D50) of the metal pigment described below. That is, the volume average particle diameter D50 can be measured by using a laser diffraction scattering type particle size distribution measuring device.

The metal particles may be produced by any method, but when the metal particles are formed of aluminum, it is preferable that the metal particles be obtained by forming a film formed of aluminum using a vapor phase film deposition method and crushing the film. Further, variations in characteristics between particles can be suppressed. In addition, even relatively thin metal particles can be suitably produced by the above-described method.

When the metal particles are produced by such a method, for example, the metal particles can be suitably produced by forming a film formed of aluminum on a base material. For example, a plastic film such as polyethylene terephthalate can be used as the base material. Further, the base material may have a release agent layer on a film deposition surface.

Further, it is preferable that the film be crushed by applying ultrasonic vibration to the film in a liquid. In this manner, the metal particles having the above-described particle diameter can be easily obtained, and occurrence of variations in the size, shape, and characteristics between metal particles can be suppressed.

Further, when the film is crushed by the above-described method, alcohols, a hydrocarbon-based compound, an ether-based compound, or a polar compound such as propylene carbonate, γ-butyrolactone, N-methyl-2-pyrrolidone, N,N-dimethylformamide, N,N-dimethylacetamide, dimethylsulfoxide, cyclohexanone, or acetonitrile can be suitably used as the liquid. When such a liquid is used, the productivity of the metal particles is particularly improved while unintentional oxidation or the like of the metal particles is suppressed, and variations in the size, shape, and characteristics between particles can be sufficiently reduced.

### 1.1.2. Surface Treatment Agent

The metal pigment is a metal particle having a surface treated with a compound represented by Formula (1) or Formula (2) as a surface treatment agent. The surface treatment agent that treats the surface of the metal particle is a compound represented by General Formula (1) or General Formula (2).

(R¹—)P(O)(OH)₂ (1)

(R²—O—)ₐP(O)(OH)₃₋ₐ (2)

(In the formulae, R¹ and R² each independently represent a hydrocarbon group having 14 or more carbon atoms which may be substituted with a substituent, and a represents 1 or 2.)

The compound (phosphonic acid of substituted or unsubstituted alkyl) represented by General Formula (1) is a compound in which the hydrogen atom of phosphonic acid has been substituted with a (R¹—) group. Since such compounds have less steric hindrance due to an alkyl moiety, the compounds are likely to be uniformly arranged on the surfaces of the metal particles, and the dispersion stability or gloss of the metal pigment can be enhanced.

The compound represented by General Formula (2) is a compound in which one or two of three hydroxyl groups of phosphoric acid are esterified with a substituted or unsubstituted alkyl group.

The compound represented by General Formula (2) is a diester body (di-body) of substituted or unsubstituted alkyl when a represents 1, and the compound represented by Formula (2) is a monoester body (mono-body) of substituted or unsubstituted alkyl when a represents 2. In a case where the compound represented by General Formula (2) is a di-body when a represents 1, the effect of making water difficult to approach the surface of the metal particle is increased by the steric hindrance due to the presence of two substituted or unsubstituted alkyl moieties, and thus the water resistance of the metal pigment can be further improved. Hereinafter, “monoester body” will also be referred to as “mono-body”, and “diester body” will also be referred to as “di-body”.

In the formulae, R¹ and R² represent a monovalent hydrocarbon group having a carbon skeleton with 14 or more carbon atoms. The hydrocarbon group may have a saturated bond or an unsaturated bond.

R¹ and R² may each independently be substituted with any one or more substituents from among a carboxyl group, a hydroxyl group, an amino group, and an oxyalkylene-containing group. In a case where R¹ and R² have a substituent, it is more preferable that R¹ or R², to which the substituent is bonded, be bonded to the carbon atom at a position farthest from P or O from the viewpoint that the dispersion stability of the metal pigment is likely to be improved. Further, among the substituents, the oxyalkylene-containing group is a group having an oxyalkylene structure, and the oxyalkylene structure is also referred to as an alkylene oxide structure.

The oxyalkylene-containing group has one or more alkylene oxide units and may have two or more alkylene oxide units. Particularly, the oxyalkylene-containing group has a plurality of alkylene oxide units, and these alkylene oxide units may have a repeating structure. The repetition number of the alkylene oxide units is preferably 10 or less and more preferably 4 or less. The lower limit thereof is 1 or greater, preferably 2 or greater, and more preferably 3 or greater. The number of carbon atoms of alkylene in the alkylene oxide unit is preferably 1 or greater and 4 or less.

Examples of the hydrocarbon group having a carbon skeleton with 14 or more carbon atoms include a saturated hydrocarbon group having no double bond nor triple bond between carbon atoms and an unsaturated hydrocarbon group having a double bond or a triple bond between carbon atoms. The hydrocarbon group may be an aromatic hydrocarbon group in which the carbon skeleton has an aromatic ring structure or a chain-like or cyclic aliphatic hydrocarbon group. Particularly, the chain-like aliphatic hydrocarbon group is preferable from the viewpoint that the dispersion stability or the like is more excellent. The chain-like aliphatic hydrocarbon group having a skeleton may be branched chain-like or linear and is preferably linear from the viewpoint that the dispersion stability, the jetting stability, the gloss, and the like are more excellent.

In the compound represented by General Formula (1) and the compound represented by General Formula (2), R¹ and R² in the formulae each independently represent preferably a hydrocarbon group having 14 or more and 32 or less carbon atoms, more preferably a hydrocarbon group having 15 or more and 30 or less carbon atoms, still more preferably a hydrocarbon group having 16 or more and 22 or less carbon atoms, and even still more preferably a hydrocarbon group having 16 or more and 20 or less carbon atoms. In this manner, the dispersion stability and the water resistance of the ink jet ink composition are further enhanced, and components can be more easily redispersed even when sedimentation of the components occurs. Further, R¹ and R² may represent an unsubstituted hydrocarbon group.

Further, R¹ and R² in General Formula (1) and General Formula (2) represent preferably hydrocarbon groups having the same number of carbon atoms and more preferably hydrocarbon groups having the same structure. In this manner, the tendency that the surface treatment agent uniformly adheres onto the surface of the metal particle becomes stronger, and the water resistance and the glossiness of the recorded material can be further enhanced in a well-balanced manner.

Specific examples of the compound represented by General Formula (1) include tetradecylphosphonic acid (myristylphosphonic acid), hexadecylphosphonic acid (cetylphosphonic acid), and octadecylphosphonic acid (stearylphosphonic acid). Among these, one or more selected from these are preferable, one or more selected from hexadecylphosphonic acid (cetylphosphonic acid) and octadecylphosphonic acid (stearylphosphonic acid) are more preferable, and octadecylphosphonic acid (stearylphosphonic acid) is still more preferable.

Specific examples of the mono-body of the compound represented by General Formula (2) include phosphoric acid monostearyl ester.

Specific examples of the di-body of the compound represented by General Formula (2) include phosphoric acid distearyl ester.

Since the compound in which a represents 2, among the compounds represented by Formula (2), that is, a phosphoric acid diester body (di-body) contains two alkyl groups and a larger amount of alkyl groups can be introduced to the surface of the metal particle, the hydrophobicity of the surface of the pigment is increased, and the water resistance and the like of the pigment can be further improved.

It is more preferable that the surface treatment agent contain any compound in which a represents 2 between the compound represented by Formula (1) and the compound represented by Formula (2). In this manner, the tendency that the surface treatment agent uniformly adheres onto the surface of the metal particle becomes stronger, and the water resistance and the glossiness can be further enhanced in a well-balanced manner.

Further, the content of the surface treatment agent is 0.5% by mass or greater and 60% by mass or less, preferably 1% by mass or greater and 50% by mass or less, more preferably 5% by mass or greater and 40% by mass or less, still more preferably 5% by mass or greater and 30% by mass or less, particularly preferably 5% by mass or greater and 20% by mass or less, and even still more preferably 5% by mass or greater and 15% by mass or less with respect to 100% by mass of the total mass of the metal particles. When the content ratio is set to be in the above-described ranges, the water resistance of the ink composition is further enhanced, and components can be more easily redispersed even when sedimentation of the components occurs.

The mass of the surface treatment agent is the mass of the surface treatment agent contained in the ink jet ink composition. When the surface treatment agent contained in the ink jet ink composition is a surface treatment agent adhered to the metal particle, the mass of the surface treatment agent is also the mass of the surface treatment agent adhered to the metal particle.

Further, the ink jet ink composition according to the present embodiment may contain a surface treatment agent other than the surface treatment agent described above as long as the effects of the present disclosure are not impaired. Examples of such a surface treatment agent include a fluorine-based compound. A compound containing fluorine and one or more selected from phosphorus, sulfur, and nitrogen as constituent elements can be preferably used as the fluorine-based compound, and specific examples thereof include fluorinated phosphonic acid, fluorinated carboxylic acid, fluorinated sulfonic acid, and salts thereof.

The surface treatment on the metal particles with the surface treatment agent may be performed, for example, by allowing a liquid to contain the surface treatment agent when a metal film formed by a vapor phase film deposition method is crushed in the liquid to form the metal particles.

### 1.1.3. Volume Average Particle Diameter

The volume average particle diameter D50 of the metal pigment obtained by treating the metal particles with the surface treatment agent is preferably 1 μm or less, more preferably 0.5 μm or less, still more preferably 20 nm or greater and 500 nm or less, even still more preferably 50 nm or greater and 400 nm or less, even still more preferably 100 nm or greater and 350 nm or less, and even still more preferably 200 nm or greater and 300 nm or less.

In a case where the particle diameter of the metal pigment is in the above-described ranges, clogging of nozzles when the ink is jetted can be reduced. Further, in the case where the particle diameter of the metal pigment is in the above-described ranges, the water resistance is enhanced and the dispersibility can be sufficiently easily obtained even when the specific surface area of the metal pigment is large.

The volume average particle diameter D50 of the metal pigment can be measured in the same manner as in the section of the metal particles.

The content of the metal pigment in the ink jet ink composition is preferably 0.3% by mass or greater and 30% by mass or less, more preferably 0.5% by mass or greater and 20% by mass or less, still more preferably 0.8% by mass or greater and 15% by mass or less, even still more preferably 1.0% by mass or greater and 10% by mass or less, and particularly preferably 1.0% by mass or greater and 5.0% by mass or less with respect to the total amount of the ink jet ink composition.

### 1.2. Polyoxyalkylene Amine Compound

The ink jet ink composition contains a polyoxyalkylene amine compound. The polyoxyalkylene amine compound is not limited as long as the polyoxyalkylene amine compound is an amine compound having a polyoxyalkylene structure in a molecule, and at least one of a compound represented by Formula (3) or a salt thereof is preferable.

R³(OC₂H₄)ₘ—(OC₃H₆)ₙ—NH₂ (3)

(In Formula (3), R³ represents a hydrogen atom or an alkyl group having 4 or less carbon atoms, m represents an integer of 1 or greater, n represents an integer of 0 or greater, and m+n is an integer of 10 or greater, where an arrangement order of an oxyethylene unit (OC₂H₄) and an oxypropylene unit (OC₃H₆) is optional.)

Further, the compound represented by Formula (3) is formed such that the average of m/(m+n)×100(%) is 20% or greater. In addition, the average of m/(m+n)×100(%) is preferably 30% or greater, more preferably 50% or greater, and still more preferably 60% or greater. The upper limit thereof is 100% or less, preferably 70% or greater and 95% or less, more preferably 73% or greater and 90% or less, still more preferably 75% or greater and 85% or less, and particularly preferably 75% or greater and 80% or less.

When the compound represented by Formula (3) in which the average thereof is in the above-described ranges is selected, the storage stability of the ink jet ink composition can be further improved, and the jetting stability of the ink jet ink composition in a case where the ink jet ink composition is stored for a long time or under severe conditions and the glossiness of a recorded material to be produced can be further improved.

Further, in the compound represented by Formula (3), the lower limit of the value of m/n which is the ratio of m to n, that is, the lower limit of the ratio of the substance amount of the oxyethylene unit to the substance amount of the oxypropylene unit in a molecule of the polyoxyalkylene amine compound is preferably 0.05, more preferably 0.15, and still more preferably 0.70. Further, the upper limit of the value of m/n is preferably 10.00, more preferably 8.00, and still more preferably 6.00.

In this manner, the storage stability of the ink jet ink composition can be further improved, and the jetting stability of the ink jet ink composition in a case where the ink jet ink composition is stored for a long time or under severe conditions and the glossiness of a recorded material to be produced can be further improved.

As described above, the order of the oxyethylene unit and the oxypropylene unit in Formula (3) is not limited. More specifically, in Formula (3), an amino group is bonded to the terminal of the continuous oxyethylene unit and a methyl group is bonded to the terminal of the continuous oxypropylene unit, but an amino group may be bonded to the terminal of the continuous oxypropylene unit and a methyl group may be bonded to the terminal of the continuous oxyethylene unit. Further, the compound represented by Formula (3) may be a block copolymer or a random copolymer.

The lower limit of the weight-average molecular weight of the polyoxyalkylene amine compound is not particularly limited, but is preferably 300, more preferably 500, still more preferably 800, and most preferably 1000. Further, the upper limit of the weight-average molecular weight of the polyoxyalkylene amine compound is not particularly limited, but is preferably 8000, more preferably 5000, and still more preferably 3000.

In this manner, the storage stability of the ink jet ink composition can be further improved, and the jetting stability of the ink jet ink composition in a case where the ink jet ink composition is stored for a long time or under severe conditions and the glossiness of a recorded material to be produced can be further improved.

The oxyethylene unit has higher hydrophilicity than that of the oxypropylene unit. The metal particles having a surface treated with the compound represented by Formula (1) or Formula (2) as the surface treatment agent have excellent dispersion stability in an organic solvent of a solvent-based ink. The compound represented by Formula (1) or Formula (2) has an excellent affinity for an organic solvent and is assumed to impart the affinity for the organic solvent to the metal particles.

However, the metal particle having a surface treated with the compound represented by Formula (1) or Formula (2) is assumed to have slightly lower hydrophobicity and stronger hydrophilicity than those of metal particles subjected to a surface treatment with a fluorine-based treatment agent that has been used in the related art. In the polyoxyalkylene amine compound represented by Formula (3) with respect to such metal particles having a surface treated with the compound represented by Formula (1) or Formula (2), it is assumed that the dispersion stability of the metal pigment is excellent by setting the average of m/(m+n)×100(%) to 20% or greater and setting the ratio of the oxyethylene unit to a predetermined amount.

Further, the content of the compound represented by Formula (3) is preferably 20% by mass or greater and 80% by mass or less, more preferably 30% by mass or greater and 60% by mass or less, and still more preferably 30% by mass or greater and 50% by mass or less with respect to 100% by mass of the total mass of the metal particles. In this manner, the dispersibility of the metal pigment can be further increased.

The lower limit of the content of the polyoxyalkylene amine compound in the ink jet ink composition is not particularly limited, but is preferably 0.01% by mass, more preferably 0.06% by mass, still more preferably 0.10% by mass, even still more preferably 0.40% by mass or greater, and even still more preferably 0.50% by mass or greater.

Further, the upper limit of the content of the polyoxyalkylene amine compound in the ink jet ink composition is not particularly limited, but is preferably 3.0% by mass, more preferably 2.0% by mass, still more preferably 1.5% by mass, and even still more preferably 0.70% by mass.

In this manner, the jetting stability of the ink jet ink composition using an ink jet method can be particularly improved, and the glossiness of the printed portion formed of the ink jet ink composition can be particularly improved.

### 1.3. Organic Solvent

The ink jet ink composition is a solvent-based ink containing an organic solvent. The organic solvent mainly functions as a dispersion medium that disperses the metal particles.

Further, the ink jet ink composition can be jetted by ink jet when the ink jet ink composition contains an organic solvent. It is preferable that the ink jet ink composition be a solvent-based ink. The solvent-based ink is a composition that contains an organic solvent as a solvent component of the composition and does not use water as a solvent component. The content of the organic solvent in the ink jet ink composition is preferably 40% by mass or greater, more preferably 50% by mass or greater, still more preferably 60% by mass or greater, even still more preferably 70% by mass or greater and 99% by mass or less, and even still more preferably 80% by mass or greater and 98% by mass or less with respect to the total amount of the ink jet ink composition. Further, the content of water in the ink jet ink composition is 1% by mass or less, preferably 0.5% by mass or less, and more preferably 0.1% by mass or less.

It is preferable that the organic solvent be formed of a liquid component other than water, usually an organic solvent. Examples of the organic solvent include a glycol ether-based organic solvent and a lactone-based organic solvent. Further, an ester compound, an ether compound, hydroxy ketone, diester carbonate, and a cyclic amide compound can also be used. More specifically, examples of the compound that can be used as the organic solvent include 2-(2-methoxy-1-methylethoxy)-1-methyl ethyl acetate, triethylene glycol dimethyl ether, triethylene glycol diacetate, diethylene glycol monoethyl ether acetate, 4-methyl-1,3-dioxolane-2-one, bis(2-butoxyethyl)ether, dimethyl glutarate, ethylene glycol di-n-butyrate, 1,3-butylene glycol diacetate, diethylene glycol monobutyl ether acetate, tetraethylene glycol dimethyl ether, 1,6-diacetoxyhexane, tripropylene glycol monomethyl ether, butoxy propanol, diethylene glycol methyl ethyl ether, diethylene glycol methyl butyl ether, triethylene glycol methyl ethyl ether, triethylene glycol methyl butyl ether, dipropylene glycol monomethyl ether acetate, diethylene glycol dimethyl ether, ethyl 3-ethoxypropionate, diethylene glycol ethyl methyl ether, 3-methoxy butyl acetate, diethylene glycol diethyl ether, ethyl octanoate, ethylene glycol monobutyl ether acetate, ethylene glycol monobutyl ether, cyclohexyl acetate, diethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, diacetyl, dipropylene glycol mono-n-propyl ether, polyethylene glycol monomethyl ether, butyl glycolate, ethylene glycol monohexyl ether, dipropylene glycol mono-n-butyl ether, N-methyl-2-pyrrolidone, triethylene glycol butyl methyl ether, bis(2-propoxyethyl)ether, diethylene glycol diacetate, diethylene glycol butyl methyl ether, diethylene glycol butyl ethyl ether, diethylene glycol butyl propyl ether, diethylene glycol ethyl propyl ether, diethylene glycol methyl propyl ether, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl methyl ether, triethylene glycol ethyl propyl ether, triethylene glycol methyl propyl ether, dipropylene glycol methyl ether acetate, n-nonyl alcohol, diethylene glycol mono-n-butyl ether, triethylene glycol monomethyl ether, ethylene glycol 2-ethyl hexyl ether, triethylene glycol monoethyl ether, diethylene glycol monohexyl ether, triethylene glycol monobutyl ether, diethylene glycol mono-2-ethyl hexyl ether, tripropylene glycol mono-n-butyl ether, butyl cellosolve acetate, and γ-butyrolactone. Among these, one or a combination of two or more selected from these can be used.

Further, the SP value of the organic solvent to be used from among these is preferably 26 MPau^{1/2} or less, more preferably 17 MPau^{1/2} or greater and 24 MPau^{1/2} or less, and still more preferably 18 MPau^{1/2} or greater and 23 MPau^{1/2} or less. Further, the SP value of the organic solvent is preferably 17 MPau^{1/2} or greater. The aligning properties of the metal pigment on the recording medium are improved by selecting such an organic solvent, and as a result, the gloss of the image is improved.

In addition, the content of the organic solvent having an SP value of 26 MPau^{1/2} or less is preferably 90% by mass or greater, more preferably 95% by mass or greater, and still more preferably 97% by mass or greater with respect to 100% by mass of the total mass of the organic solvent. The upper limit thereof is 100% by mass or less. From the viewpoint that the dispersion stability and the like are more excellent in the ink containing metal particles having a surface treated with the compound represented by Formula (1) or Formula (2) and a polyoxyalkylene amine compound represented by Formula (3), it is more preferable that the content of the organic solvent having an SP value of 26 MPa^{1/2} or less be in the above-described ranges.

In the present specification, the solubility parameter (SP value) is a value (unit: MPa^{1/2}) acquired by an Okitsu method. The Okitsu method is one of the known methods of calculating the SP value in the related art and is, for example, a method described in Journal of the Adhesion Society of Japan, Vol. 29, No. 6 (1993), pp. 249 to 259.

Further, among the above-described organic solvent, a glycol ether-based organic solvent or a lactone-based organic solvent is more preferable, and a glycol ether-based organic solvent is still more preferable. Examples of the glycol ether-based organic solvent include glycol monoether and glycol diether. Among these, glycol diether is preferable. It is particularly preferable that the ink jet ink composition contain one or more selected from diethylene glycol diethyl ether, ethylene glycol ethyl methyl ether, triethylene glycol monobutyl ether, tetraethylene glycol monobutyl ether, and γ-butyrolactone.

The lower limit of the content of the organic solvent in the ink jet ink composition is not particularly limited, but is preferably 50.0% by mass, more preferably 60.0% by mass, and still more preferably 70.0% by mass. Further, the upper limit of the content of the organic solvent in the ink jet ink composition is not particularly limited, but is preferably 99.8% by mass, more preferably 99.5% by mass, and still more preferably 99.0% by mass. It is also preferable that the content of the glycol ether-based organic solvent be set to be in the above-described ranges.

### 1.4. Other Components

The ink jet ink composition according to the present embodiment may contain components other than the components described above. Examples of such components include a leveling agent, a binder, a polymerization accelerator, a polymerization inhibitor, a photopolymerization initiator, a dispersant, a surfactant, a penetration accelerator, a moisturizing agent, a coloring agent, a fixing agent, a fungicide, a preservative, an antioxidant, a chelating agent, a thickener, and a sensitizer.

The binder is not limited as long as the binder is a resin, and preferred examples thereof include an acrylic resin, an ester-based resin, and a urethane-based resin. Among these, an acrylic resin is more preferable. When the ink jet ink composition contains a binder, the content of the binder in the composition is preferably 0.1% by mass or greater and preferably 1% by mass or less and more preferably 0.5% by mass or less.

Preferred examples of the surfactant include a silicone-based surfactant, a fluorine-based surfactant, and an acetylene glycol-based surfactant. Among these, a silicone-based surfactant is particularly preferable. When the ink jet ink composition contains a surfactant, the content of the surfactant in the composition is preferably 0.1% by mass or greater and preferably 1% by mass or less and more preferably 0.5% by mass or less.

Further, the ink jet ink composition may contain a small amount of water in addition to the above-described organic solvent. Here, the content of water in the ink jet ink composition is preferably 1.0% by mass or less, more preferably 0.5% by mass or less, and still more preferably 0.1% by mass or less.

### 1.5. Physical Properties of Ink Jet Ink Composition

The viscosity of the ink jet ink composition is measured by using a vibration type viscometer in conformity with JIS Z 8809. The upper limit of the viscosity of the present ink jet ink composition at 20° C. is not particularly limited, but is preferably 25 mPa·s, more preferably 15 mPa·s, still more preferably 10 mPa·s or less, and even still more preferably 5 mPa·s or less. Further, the lower limit of the viscosity of the ink jet ink composition at 20° C. is not particularly limited, but is more preferably 1 mPa·s. In this manner, liquid droplets can be more suitably jetted by the ink jet method.

### 2. Recording Method

The recording method according to the present embodiment includes a step of making the above-described ink jet ink composition adhere to the recording medium. In this manner, a recording method that enables recording of a recorded material with excellent jetting stability, excellent dispersion stability of the ink, and excellent glossiness can be provided.

Examples of the recording medium include an ink absorbing recording medium such as paper or fabric. The ink absorbing recording medium is a recording medium having a recording surface that easily absorbs an ink. Examples of the paper include plain paper, paper used exclusively for ink jet, and corrugated cardboard. Examples of the fabric include natural fibers/synthetic fibers such as cotton, polyester, and wool, and non-woven fabric.

Further, other examples of the recording medium include a non-absorbing recording medium consisting of a plastic material, a metal, glass, ceramics, wood, or the like. The non-absorbing recording medium is a recording medium having a recording surface that is unlikely to absorb an ink. Examples of the recording medium consisting of a plastic material include a plastic film and a plastic sheet. The plastic is not limited, and examples thereof include vinyl chloride, polyester, and polyolefin. Examples of the polyester include polyethylene terephthalate.

Further, other examples of the recording medium also include a low-absorbing recording medium. The low-absorbing recording medium is a recording medium having a recording surface having the second lowest absorbency after the non-absorbing recording medium. Examples of the low-absorbing recording medium include a recording medium having a surface provided with a coating layer (receiving layer) for receiving a liquid, and examples of the recording medium in which the base material is paper include actual printing paper. Examples of the coating layer include a coating layer that is unlikely to absorb an ink and is coated with particles of an inorganic compound together with a binder.

The low-absorbing or non-absorbing recording medium denotes a recording medium having a property of not absorbing a liquid or hardly absorbing a liquid. For example, it is preferable that the non-absorbing or low-absorbing recording medium be “recording medium in which the water absorption amount from the start of contact to 30 msecu^{1/2} in the Bristow method is 10 mL/m² or less”.

The Bristow method is a method that has been widely used as a method of measuring the liquid absorption amount in a short time and that is also adopted by Japan Technical Association of The Pulp And Paper Industry (JAPAN TAPPI). The details of the test method are described in Standard No. 51 “Paper and Paperboard, Liquid Absorbency Test Method, Bristow Method” of “Paper and Pulp Test Method (2000) by JAPAN TAPPI”.

Meanwhile, an absorbing recording medium denotes a recording medium that does not correspond to the non-absorbing or low-absorbing recording medium.

Further, the shape of the recording medium is not particularly limited and may be any of a sheet shape, a plate shape, an object shape, or the like.

When the ink composition is jetted by an ink jet method, a piezo method, a method of jetting an ink using bubbles formed by heating the ink, or the like can be used, but a piezo method is preferable from the viewpoint that the metal pigment is unlikely to be deteriorated.

The ink composition can be jetted by the ink jet method using a known liquid droplet jetting device.

A colored portion formed by the ink composition may have, for example, a predetermined pattern and may be formed on the entire surface of an object to be treated.

### 2.1 Primary Heating Step

The recording method according to the present embodiment may include a primary heating step of heating the ink composition adhered to the recording medium at an early stage. The primary heating step is a step of heating the ink adhered to the recording medium at an early stage and drying the ink. The primary heating step is a heating step for drying at least a part of a liquid medium of the ink adhered to a recording medium at least to an extent that the flow of the ink is reduced. The primary heating step may be performed such that the ink adheres to a heated recording medium or the ink is heated at an early stage after the adhesion. It is preferable that the ink droplets having landed on the recording medium start heating at the latest 0.5 seconds after the landing of the ink droplets.

It is preferable that the primary heating step be performed by irradiating the recording medium with an IR heater or a microwave or blowing hot air to the recording medium using a platen heater or a fan.

The heating in the primary heating step may be performed at least at any timing of before the ink adhesion step, simultaneously with the adhesion, or early after the adhesion, and it is preferable that the heating be performed simultaneously with the adhesion. In this heating order, the ink adhesion step can be performed. It is particularly preferable that the recording medium be heated and the ink composition adhere to the heated recording medium in the ink adhesion step.

When the recording method includes the primary heating step, since the ink composition on the recording medium can be rapidly dried, occurrence of bleeding of the ink can be prevented, which is preferable.

The surface temperature of the recording surface of the recording medium in the primary heating step of heating the ink composition is preferably 30° C. or higher and 60° C. or lower, more preferably 35° C. or higher and 55° C. or lower, and still more preferably 40° C. or higher and 50° C. or lower. It is preferable that the surface temperature of the recording medium be in the above-described ranges from the viewpoint of preventing bleeding and further improving the jetting stability.

Further, the surface temperature of the recording medium in the primary heating step is the surface temperature of the recording medium when the ink adheres to the recording medium or the temperature of the recording medium during heating when the recording medium is heated after the adhesion. Further, the surface temperature of the recording medium is a maximum temperature during recording.

### 2.2. Post-Heating Step

The recording method according to the present embodiment may include a post-heating step (secondary heating step) of heating the recording medium after the ink adhesion step. The post-heating step is a heating step of completing recording and sufficiently heating the recording medium to the extent that the recorded material can be used. The post-heating step is a heating step for sufficiently drying a solvent component of the ink. It is preferable that the post-heating step be started longer than 0.5 seconds after the adhesion of the ink to the recording medium. For example, it is preferable that a recording region where the recording medium is present start heating longer than 0.5 seconds after completion of the adhesion of the ink to the recording region.

The recording medium in the post-heating step can be performed by using, for example, an appropriate heating unit. The surface temperature of the recording medium in this case is preferably 40° C. or higher, more preferably 45° C. or higher, and still more preferably 50° C. or higher. The upper limit thereof is not limited, but is preferably 120° C. or lower, more preferably 75° C. or lower, still more preferably 70° C. or lower, and even still more preferably 60° C. or lower.

Further, the heating temperature is preferably lower than or equal to the softening point of the base material of the recording medium.

### 3. Recording Device

As an example of a recording device that performs the recording method according to the present embodiment, a recording device that includes a recording head jetting the ink composition containing a metal pigment and making the ink composition adhere to a recording medium and a recording head jetting the colored ink and making the colored ink adhere to the recording medium, and performs recording using the above-described recording method may be exemplified.

### 3.1. Outline of Device Configuration

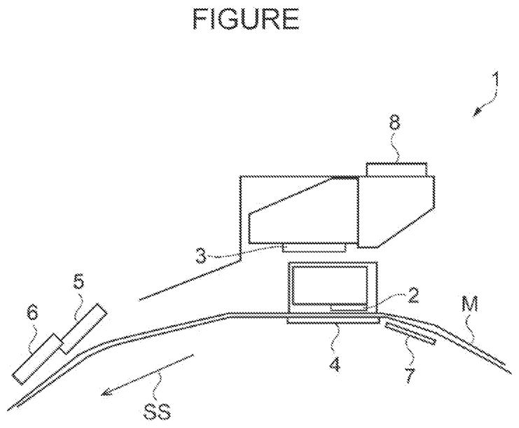

FIG. 1s a schematic cross-sectional view schematically showing a recording device. As shown in FIGURE, an ink jet recording device 1 includes a recording head 2, an IR heater 3, a platen 4, a heating heater 5, a cooling fan 6, a preheater 7, and a ventilation fan 8. Further, the recording head is mounted on a carriage (not shown) and performs main scanning in a front-rear direction of the FIGURE so that the ink adheres to a recording medium M. Further, the platen 4 is provided with a platen heater (not shown). The recording device 1 includes a control unit (not shown) and performs recording by controlling each unit. Further, the recording head 2 receives the ink supplied from an ink housing body (not shown).

### 3.2. Configuration Related to Ink Jet Head

The recording head 2, which is an ink jet head, is configured to perform recording on the recording medium M by jetting the ink composition from a nozzle of the recording head 2 to make the ink composition adhere to the recording medium M. The recording head 2 shown in FIG. 1s a serial type recording head and performs scanning on the recording medium M a plurality of times relatively in a main scanning direction so that the ink adheres to the recording medium M. The recording head 2 is mounted on the carriage (not shown). The recording head 2 performs scanning on the recording medium M a plurality of times relatively in a main scanning direction by an operation of a carriage moving mechanism that allows the carriage to move in a medium width direction (front-rear direction of the FIGURE) of the recording medium M. The medium width direction is a main scanning direction of the recording head 2. The scanning carried out in the main scanning direction is also referred to as main scanning.

Here, the main scanning direction is a direction in which the carriage on which the recording head 2 is mounted moves. In FIGURE, the main scanning direction is a direction intersecting a sub-scanning direction which is a transport direction of the recording medium M indicated by an arrow SS. Further, an image is recorded on the recording medium M by repeatedly performing main scanning of the recording head 2 and sub-scanning which is the transport of the recording medium M a plurality of times.

The ink composition can be jetted from the recording head 2 using a known method of the related art. For example, a method of jetting liquid droplets using vibration of a piezoelectric element, that is, a jetting method of forming ink droplets by mechanical deformation of an electrostrictive element is used.

### 3.3. Primary Heating Mechanism

The ink jet recording device 1 may include a primary heating mechanism that performs the primary heating step of heating the recording medium M when the ink is jetted from the recording head 2 and made to adhere to the recording medium. As the primary heating mechanism, a conduction type heating mechanism, a blast type heating mechanism, a radiation type heating mechanism, or the like can be used. The conduction type heating mechanism conducts heat from a member in contact with the recording medium to the recording medium. Examples thereof include a platen heater. Further, the platen heater is not shown in the FIGURE, but is integrated with the platen 4. The blast type heating mechanism dries the ink by sending normal temperature air or hot air to the recording medium. Examples thereof include a blast fan. The radiation type heating mechanism heats the recording medium by radiating radiation that generates heat to the recording medium. Examples thereof include IR radiation. Although not shown, a heater similar to the platen heater may be provided immediately downstream of the platen 4 in the SS direction. These primary heating mechanisms may be used alone or in combination.

For example, the recording device includes the IR heater 3 and the platen heater as the primary heating mechanism.

Further, when the IR heater 3 is used, the recording medium M can be heated in a radiation manner by infrared rays radiated from the recording head 2 side. In this manner, the recording head 2 is also likely to be heated simultaneously, but the recording medium M can be heated without being affected by the thickness of the recording medium M as compared to when the recording medium M is heated from the rear surface thereof using the platen heater or the like. Further, the primary heating mechanism may include various fans (such as the ventilation fan 8) that apply hot air or air at the same temperature as the temperature of the environment to the recording medium M to dry the ink on the recording medium M.

The platen heater can heat the recording medium M at a position opposing to the recording head 2 via the platen 4. The platen heater is capable of heating the recording medium M in a conduction manner and is used as necessary in the ink jet recording method.

Further, the ink jet recording device 1 may include the preheater 7 that heats the recording medium M in advance before the ink adheres to the recording medium M.

### 3.4. Post-Heating Mechanism

The recording device may also include a post-heating mechanism that performs a post-heating step of heating the recording medium after a white ink adhesion step and a non-white ink adhesion step and drying and fixing the ink.

The heating heater 5 used for the post-heating mechanism dries and solidifies the ink adhered to the recording medium M. When the heating heater 5 heats the recording medium M on which an image has been recorded, the moisture and the like contained in the ink can be more rapidly evaporated and scattered so that an ink film is formed of the resin contained in the ink. In this manner, the ink film is firmly fixed or bonded on the recording medium M, and thus the film-forming properties are improved and an excellent high-quality image can be obtained in a short time.

### 3.5. Other Configurations

The ink jet recording device 1 may include the cooling fan 6. An ink coating film can be formed on the recording medium M with excellent adhesiveness by drying the ink recorded on the recording medium M and cooling the ink on the recording medium M with the cooling fan 6.

The recording device shown in FIG. 1s a serial printer that performs so-called serial type recording. The recording device may be a line printer that includes a line head and performs line type recording.

The line head includes a nozzle array in which a plurality of nozzles are aligned in the width direction of the recording medium and has a length greater than or equal to the width of the recording medium M to be transported, and thus an image can be recorded at once on the recording medium M to be transported in the width direction of the recording medium. Further, recording can be performed by scanning once. In addition, recording performed by scanning twice or more times can also be carried out by performing scanning once performed by transporting the recording medium, returning the recording medium in a direction opposite to the transport direction, transporting the recording medium again, and performing scanning again.

Further, the scanning may be performed by the head in which the position with respect to the recording medium to be transported is fixed or the scanning may be performed while the head moves with respect to the recording medium fixed in the platen region.

Further, a recording device capable of performing line type recording can be configured as shown in FIGURE except that the recording head 2 is changed to a line head. Specifically, the heating mechanisms such as the ventilation fan 8, the IR heater 3, the platen heater, and the preheater 7 above the recording head 2 shown in FIGURE may be similarly provided above or below the line head. Further, the recording device may include the heating heater 5 serving as a post-heating mechanism shown in FIGURE and the cooling fan 6.

### 4. Examples and Comparative Examples

Hereinafter, the present disclosure will be described in more detail based on examples, but the present disclosure is not limited to such examples. Hereinafter, “%” is on a mass basis unless otherwise specified.

### 4.1. Preparation of Ink Jet Ink Composition

First, a polyethylene terephthalate film having a thickness of 20 μm and a smooth surface with a surface roughness Ra of 0.02 μm or less was prepared. Next, a release layer was formed on one entire surface of the film by coating the surface with a release resin solubilized by acetone using a roll coater. The polyethylene terephthalate film on which the release layer had been formed was transported into a vacuum deposition device at a speed of 5 m/s to form a film formed of Al with a thickness of 16 nm under reduced pressure.

Next, the polyethylene terephthalate film on which the Al film had been formed was immersed in tetrahydrofuran, and ultrasonic vibration at 40 kHz was applied thereto, thereby obtaining a dispersion liquid of metal particles made of Al.

The tetrahydrofuran was removed by a centrifuge, and diethylene glycol diethyl ether was added thereto, thereby obtaining a suspension in which the content of the metal particles was 5% by mass.

Next, the suspension was treated with a circulation type high-output ultrasonic crusher so that the metal particles were crushed into a predetermined size. Ultrasonic waves at 20 kHz were applied in the treatment.

Next, the aggregation of the metal particles was loosened by performing a heat treatment on the suspension at 55° C. for 2 hours while irradiating the suspension with ultrasonic waves at 40 kHz, to disperse the metal particles in a state of primary particles. Thereafter, a treatment agent listed in each table and a compound “poly(EO/PO)amine” represented by Formula (3) listed in each table were added to the suspension such that the ratio of the mass of the treatment agent or the mass of the compound to the mass of the metal particles is as listed in each table.

Further, the treatment agent was allowed to react on the surface of the metal particle by performing a heat treatment on the suspension at 55° C. while irradiating the suspension with ultrasonic waves at 28 kHz, thereby obtaining a dispersion liquid of the metal pigment having a surface modified with the treatment agent. Further, the organic solvent was separated from the obtained dispersion liquid with a centrifuge for confirmation, and as a result, the organic solvent did not contain the treatment agent. As shown in the result, the treatment agent was assumed to adhere to the metal particles.

Thereafter, the organic solvents and the binder were added to the obtained dispersion liquid of the metal pigment, thereby obtaining an ink jet ink composition of each example. The ink composition was a solvent-based composition.

As the results of measuring the volume average particle diameters of the metal pigments contained in the ink compositions of the examples which had been obtained in the above-described manner, the diameters thereof were 0.25 μm except for Example 6-9, and the average thickness was 16 nm. Further, the volume average particle diameter of the metal pigment of Example 6-9 was adjusted by changing the treatment time with a circulation type high-output ultrasonic wave crusher.

The configurations and the compositions of the metal pigments contained in the ink compositions in each example and each comparative example are collectively listed in Tables 1 to 3. The content of each component will be described below.
Tridecylphosphoric acid (Tokyo Chemical Industry Co., Ltd.)
Tetradecylphosphoric acid (Tokyo Chemical Industry Co., Ltd.)
Octadecyl phosphonate (Tokyo Chemical Industry Co., Ltd.)
Dodecylphosphonic acid (Tokyo Chemical Industry Co., Ltd.)
Stearylphosphoric acid (Tokyo Chemical Industry Co., Ltd.)
Tetracosylphosphoric acid (Tokyo Chemical Industry Co., Ltd.)
Octadecyltrimethoxysilane (Tokyo Chemical Industry Co., Ltd.)
FAS13: 1H,1H,2H,2H-perfluorooctyltrimethoxysilane
FHP: 2-(perfluorohexyl)ethylphosphonic acid (Tokyo Chemical Industry Co., Ltd.)
SURFONAMINE L-200: compound which is a polyoxyalkylene amine compound represented by Formula (3) and in which the average of m/(m+n)×100(%) is 91% or greater, manufactured by Huntsman Corporation
SURFONAMINE L-100: compound which is a polyoxyalkylene amine compound represented by Formula (3) and in which the average of m/(m+n)×100(%) is 86% or greater, manufactured by Huntsman Corporation
SURFONAMINE L-207: compound which is a polyoxyalkylene amine compound represented by Formula (3) and in which the average of m/(m+n)×100(%) is 77% or greater, manufactured by Huntsman Corporation
SURFONAMINE B-200: compound which is a polyoxyalkylene amine compound represented by Formula (3) and in which the average of m/(m+n)×100(%) is 17% or greater, manufactured by Huntsman Corporation
SURFONAMINE B-600: compound which is a polyoxyalkylene amine compound represented by Formula (3) and in which the average of m/(m+n)×100(%) is 10% or greater, manufactured by Huntsman Corporation
SURFONAMINE FL-1000: compound which is a polyoxyalkylene amine compound represented by Formula (3) and in which the average of m/(m+n)×100(%) is 0% or greater, manufactured by Huntsman Corporation

The weight-average molecular weights of all the polyoxyalkylene amine compound represented by Formula (3) were in a range of 600 to 3000.
DEDG: diethylene glycol diethyl ether, SP value: 17.9 MPa^{1/2}
MEDG: diethylene glycol monoethyl ether, SP value: 18.2 MPa^{1/2}
BTGH: tetraethylene glycol monobutyl ether, SP value: 20.6 MPa^{1/2}
γBL: γ-butyrolactone, SP value: 23.1 MPa^{1/2}
PG: propylene glycol, SP value: 28.7 MPa^{1/2}
PARALOID B60: binder (acrylic resin, manufactured by The Dow Chemical Company)

The volume average particle diameter D (D50) of the metal pigment in the tables was measured by using MICROTRAC MT-3300 (manufactured by MicrotracBEL Corp., laser diffraction scattering type particle size distribution measuring device). Further, the viscosity of the ink composition in each example at 25° C. which was measured in conformity with JIS Z 8809 using a rotational viscometer was a value in a range of 1.5 mPa·s or greater and 15 mPa·s or less.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Pigment | Aluminum | 1.5 | 1.5 | 1.5 | 1.5 | 1.5 | 1.5 | 1.5 | 1.5 |
| | pigment | | | | | | | | |
| Treatment | Stearylphosphoric | 0.15 | 0.15 | 0.15 | 0.15 | 0.15 | 0.15 | 0.15 | 0.15 |
| agent | acid | | | | | | | | |
| Poly(EO/PO) | SURFONAMINE | 0.6 | — | — | — | — | — | — | — |
| amine (EO | L-200 (91%) | | | | | | | | |
| ratio) | SURFONAMINE | — | 0.6 | — | 1.2 | 0.3 | 0.6 | 0.6 | 0.6 |
| | L-100 (86%) | | | | | | | | |
| | SURFONAMINE | — | — | 0.6 | — | — | — | — | — |
| | L-207 (77%) | | | | | | | | |
| Organic | DEDG (17.9) | 59.9 | 59.9 | 59.9 | 59.3 | 60.2 | 59.9 | 59.9 | 59.9 |
| solvent (SP | MEDG (18.2) | 22.8 | 22.8 | 22.8 | 22.8 | 22.8 | 22.8 | 22.8 | 22.8 |
| value) | BTGH (20.6) | 10.0 | 10.0 | 10.0 | 10.0 | 10.0 | 10.0 | 10.0 | 10.0 |
| | γBL (23.1) | 5.0 | 5.0 | 5.0 | 5.0 | 5.0 | 5.0 | 5.0 | 5.0 |
| Binder | PARALOID B60 | 0.1 | 0.1 | 0.1 | 0.1 | 0.1 | 0.1 | 0.1 | 0.1 |
| Total | | 100 | 100 | 100 | 100 | 100 | 100 | 100 | 100 |
| Physical | Particle diameter | 0.25 | 0.25 | 0.25 | 0.25 | 0.25 | 0.3 | 0.05 | 0.5 |
| property of | of pigment (μm) | | | | | | | | |
| ink | | | | | | | | | |
| Evaluation | Dispersion | B | A | A | A | B | A | A | A |
| | stability | | | | | | | | |
| | Gloss | A | A | A | B | A | A | B | A |
| | Sedimentation | A | A | A | A | A | B | A | C |
| | property | | | | | | | | |

| | | Example | Example | Example | Example | Example | Example | Comparative | Comparative | Comparative |
|---|---|---|---|---|---|---|---|---|---|---|
| | | 9 | 10 | 11 | 12 | 13 | 14 | Example 1 | Example 2 | Example 3 |
| Pigment | Aluminum pigment | 1.5 | 1.5 | 1.5 | 1.5 | 1.5 | 1.5 | 1.5 | 1.5 | 1.5 |
| Treatment | Tetradecylphos- | — | 0.15 | — | — | — | — | — | — | — |
| agent | phoric acid | | | | | | | | | |
| | Octadecyl | — | — | 0.15 | — | — | — | — | — | — |
| | phosphonate | | | | | | | | | |
| | Stearylphosphoric | 0.15 | — | — | — | 0.15 | 0.15 | 0.15 | 0.15 | 0.15 |
| | acid | | | | | | | | | |
| | Tetracosylphos- | — | — | — | 0.15 | — | — | — | — | — |
| | phoric acid | | | | | | | | | |
| Poly(EO/PO) | SURFONAMINE | — | 0.6 | 0.6 | 0.6 | — | — | — | — | — |
| amine (EO | L-200 (91%) | | | | | | | | | |
| ratio) | SURFONAMINE | 0.6 | — | — | — | 0.6 | — | — | — | — |
| | L-100 (86%) | | | | | | | | | |
| | SURFONAMINE | — | — | — | — | — | 0.3 | — | — | — |
| | L-207 (77%) | | | | | | | | | |
| | SURFONAMINE | — | — | — | — | — | — | 0.6 | — | — |
| | B-200 (17%) | | | | | | | | | |
| | SURFONAMINE | — | — | — | — | — | — | — | 0.6 | — |
| | FL-1000 (0%) | | | | | | | | | |
| Organic | DEDG (17.9) | 59.9 | 59.9 | 59.9 | 59.9 | 54.9 | 60.2 | 59.9 | 59.9 | 60.5 |
| solvent (SP | MEDG (18.2) | 22.8 | 22.8 | 22.8 | 22.8 | 22.8 | 22.8 | 22.8 | 22.8 | 22.8 |
| value) | BTGH (20.6) | 10.0 | 10.0 | 10.0 | 10.0 | 10.0 | 10.0 | 10.0 | 10.0 | 10.0 |
| | γBL (23.1) | 5.0 | 5.0 | 5.0 | 5.0 | 5.0 | 5.0 | 5.0 | 5.0 | 5.0 |
| | PG (28.7) | — | — | — | — | 5.0 | — | — | — | — |
| Binder | PARALOID B60 | 0.1 | 0.1 | 0.1 | 0.1 | 0.1 | 0.1 | 0.1 | 0.1 | 0.1 |
| Total | | 100 | 100 | 100 | 100 | 100 | 100 | 100 | 100 | 100 |
| Physical | Particle diameter of | 0.025 | 0.25 | 0.25 | 0.25 | 0.25 | 0.25 | 0.25 | 0.25 | 0.25 |
| property of | pigment (μm) | | | | | | | | | |
| ink | | | | | | | | | | |
| Evaluation | Dispersion stability | C | B | A | A | C | A | D | D | E |
| | Gloss | D | B | B | A | C | A | D | D | E |
| | Sedimentation | C | A | A | A | B | A | D | D | D |
| | property | | | | | | | | | |

| | | Comparative | Comparative | Comparative | Comparative | Comparative | Comparative | Comparative |
|---|---|---|---|---|---|---|---|---|
| | | Example 4 | Example 5 | Example 6 | Example 7 | Example 8 | Example 9 | Example 10 |
| Pigment | Aluminum pigment | 1.5 | 1.5 | 1.5 | 1.5 | 1.5 | 1.5 | 1.5 |
| Treatment | Tridecylphosphoric acid | — | 0.15 | — | — | — | — | — |
| agent | Stearylphosphoric acid | 0.15 | — | — | — | — | — | — |
| | Octadecyltrimethoxysilane | — | — | 0.15 | — | — | — | — |
| | FAS13 | — | — | — | 0.15 | — | — | — |
| | FHP | — | — | — | — | 0.15 | 0.15 | 0.15 |
| Poly(EO/PO) | SURFONAMINE L-100 | — | — | 0.6 | 0.6 | 0.6 | — | — |
| amine (EO | (86%) | | | | | | | |
| ratio) | SURFONAMINE B-200 | — | — | — | — | — | 0.6 | — |
| | (17%) | | | | | | | |
| | SURFONAMINE B-600 | 0.6 | — | — | — | — | — | — |
| | (10%) | | | | | | | |
| | SURFONAMINE FL-1000 | — | — | — | — | — | — | 0.6 |
| | (0%) | | | | | | | |
| Organic | DEDG (17.9) | 59.9 | 60.5 | 59.9 | 59.9 | 59.9 | 59.9 | 59.9 |
| solvent (SP | MEDG (18.2) | 22.8 | 22.8 | 22.8 | 22.8 | 22.8 | 22.8 | 22.8 |
| value) | BTGH (20.6) | 100 | 100 | 100 | 100 | 100 | 100 | 100 |
| | γBL (23.1) | 5.0 | 5.0 | 5.0 | 5.0 | 5.0 | 5.0 | 5.0 |
| Binder | PARALOID B60 | 0.1 | 0.1 | 0.1 | 0.1 | 0.1 | 0.1 | 0.1 |
| Total | | 100 | 100 | 100 | 100 | 100 | 100 | 100 |
| Physical | Particle diameter of pigment | 0.25 | 0.25 | 0.25 | 0.25 | 0.25 | 0.25 | 0.25 |
| property of | | | | | | | | |
| ink | | | | | | | | |
| Evaluation | Dispersion stability | D | D | D | D | D | D | D |
| | Gloss | D | D | D | D | D | D | D |
| | Sedimentation property | D | D | D | D | D | D | D |

### 4.2. Evaluation Method

### 4.2.1. Recording Device

A recording device was prepared. A modified machine (SC-S80650, manufactured by Seiko Epson Corporation) was used. The nozzle density of the nozzle array of the ink jet head was set to 360 npi and the 360-nozzle was used. The ink jet head was filled with the ink. The driving waveform of the ink jet head filled with the ink was optimized such that optimal jetting of the ink was carried out. The platen heater was controlled during recording, and the surface temperature of the recording medium on the platen during the recording was set to 40° C. as the primary heating step.

The post-heating step was performed by operating the after-heater during the recording, and the surface temperature of the recording medium in the post-heating step was set to 50° C. The recording was performed by using a polyvinyl chloride film (Mactac 5829R, manufactured by Mactac) as the recording medium.

When the recording was performed, the ink adhesion amount in the recording pattern was set to 3 mg/inch², and the recording resolution was set to 1440×1440 dpi. In this manner, the recording test was performed.

### 4.2.2. Dispersion Stability (Long-Term Storage Stability)

An ink pack in which the ink jet ink composition in each example and each comparative example was poured was stored at 65° C. for 15 days. An increase rate of the average particle diameter after the storage to the average particle diameter before the storage was confirmed. The dispersion stability was evaluated according to the following criteria, and the results are listed in the tables.
A: The increase rate was 1% or less.
B: The increase rate was greater than 1% and 2% or less.
C: The increase rate was greater than 2% and 4% or less.
D: The increase rate was greater than 4% and 6% or less.
E: The increase rate was greater than 6%.

### 4.2.3. Evaluation of Gloss

The glossiness of the recorded portion of the recorded material in each example which had been obtained by the recording test was measured at a tilt angle of 60° using a gloss meter (MINOLTA MULTI GLOSS 268A), and the glass was evaluated according to the following criteria. The glossiness is more excellent as the value increases.
Evaluation criteria
A: The glossiness was 450 or greater
B: The glossiness was 400 or greater and less than 450
C: The glossiness was 350 or greater and less than 400
D: The glossiness was 300 or greater and less than 350
E: The glossiness was less than 300

### 4.2.4. Evaluation of Sedimentation

The ink jet ink obtained in each example and each comparative example was poured into a container and stored at room temperature for 2 months. Thereafter, the sedimentation was visually evaluated according to the following criteria, and the results are listed in the tables.
A: Sedimentation of the metal pigment was not found.
B: Sedimentation of the metal pigment was slightly found.
C: Sedimentation of the metal pigment was found, but sedimentation of the metal pigment was no longer found after shaking the container ten times.
D: Sedimentation of the metal pigment was found, and was still found after shaking the container ten times.

### 4.3. Evaluation Results

It was found that the solvent-based ink jet ink composition of each example, containing the metal pigment having a surface treated with a compound represented by Formula (1) or Formula (2), the polyoxyalkylene amine compound containing a compound represented by Formula (3), and the organic solvent, in which the average of m/(m+n)×100(%) was 20% or greater, had satisfactory dispersibility and was capable of obtaining a recorded material with excellent gloss.

The embodiments and the modified examples described above are merely examples, and the present disclosure is not limited thereto. For example, each embodiment and each modified example can be appropriately used in combination.

The present disclosure is not limited to the above-described embodiments, and various modifications can be made. For example, the present disclosure has configurations that are substantially the same as the configurations described in the embodiments, for example, configurations with the same functions, the same methods, and the same results as described above or configurations with the same purposes and the same effects as described above. Further, the present disclosure has configurations in which parts that are not essential in the configurations described in the embodiments have been substituted. Further, the present disclosure has configurations exhibiting the same effects as the effects of the configurations described in the embodiments or configurations capable of achieving the same purposes as the purposes of the configurations described in the embodiments. Further, the present disclosure has configurations in which known techniques have been added to the configurations described in the embodiments.

The following contents can be derived from the embodiments and the modified examples described above.

An ink jet ink composition which is a solvent-based ink jet ink composition, the composition including: a metal pigment; a polyoxyalkylene amine compound; and an organic solvent, in which the metal pigment is a metal particle having a surface treated with a surface treatment agent, the surface treatment agent is a compound represented by Formula (1) or Formula (2), the polyoxyalkylene amine compound includes a compound represented by Formula (3), and the compound represented by Formula (3) is formed such that an average of m/(m+n)×100(%) is 20% or greater.

(R¹—)P(O)(OH)₂ (1)

(R²—O—)ₐP(O)(OH)₃₋ₐ (2)

(In Formulae (1) and (2), R¹ and R² each independently represent a hydrocarbon group having 14 or more carbon atoms which may be substituted with a substituent, and a represents 1 or 2.)

R³(OC₂H₄)ₘ—(OC₃H₆)ₙ—NH₂ (3)

(In Formula (3), R³ represents a hydrogen atom or an alkyl group having 4 or less carbon atoms, m represents an integer of 1 or greater, n represents an integer of 0 or greater, and m+n is an integer of 10 or greater, where an arrangement order of an oxyethylene unit (OC₂H₄) and an oxypropylene unit (OC₃H₆) is optional.)

According to the ink jet ink composition, a recorded material in which the water resistance of the metal pigment is satisfactory, the dispersibility of the metal pigment is excellent, and the gloss is satisfactory can be obtained.

In the ink jet ink composition described above, a content of the compound represented by Formula (3) may be 20% by mass or greater and 80% by mass or less with respect to 100% by mass of a total mass of the metal particle.

According to the ink jet ink composition, the dispersibility of the metal pigment is more excellent.

In the ink jet ink composition described above, the metal pigment may have a volume average particle diameter D50 of 0.5 μm or less.

According to the ink jet ink composition, the ink jet ink composition is more suitable for the ink jet method.

In the ink jet ink composition described above, the metal pigment may have a scaly shape and an average thickness of 30 nm or less.

According to the ink jet ink composition, an image with more excellent metallic gloss can be formed.

In the ink jet ink composition described above, a content of the organic solvent having an SP value of 26 MPau^{1/2} or less may be 90% by mass or greater with respect to 100% by mass of a total mass of the organic solvent.

According to the ink jet ink composition, the dispersibility of the metal pigment is more excellent.

In the ink jet ink composition described above, the organic solvent is selected from a glycol ether-based organic solvent and a lactone-based organic solvent.

In the ink jet ink composition described above, a content of the organic solvent may be 50% by mass or greater with respect to a total amount of the ink jet ink composition.

In the ink jet ink composition described above, R¹ and R² may represent an unsubstituted hydrocarbon group.

According to the ink jet ink composition, the water resistance of the metal pigment is more excellent.

In the ink jet ink composition described above, R¹ and R² represent a hydrocarbon group having 15 or more and 30 or less carbon atoms.

According to the ink jet ink composition, the water resistance of the metal pigment is more excellent.

In the ink jet ink composition described above, the metal particle may consist of aluminum or an aluminum alloy.

According to the ink jet ink composition, an image with more satisfactory metallic gloss can be obtained.

A recording method includes making the ink jet ink composition described above adhere to a recording medium.

According to the recording method, a coating film with satisfactory water resistance and satisfactory gloss can be formed.

What is claimed is:

1. An ink jet ink composition which is a solvent-based ink, the composition comprising:
a metal pigment;
a polyoxyalkylene amine compound; and
an organic solvent,
wherein the metal pigment is a metal particle having a surface treated with a surface treatment agent,
the surface treatment agent is a compound represented by Formula (1) or Formula (2),
the polyoxyalkylene amine compound includes a compound represented by Formula (3), and
the compound represented by Formula (3) is formed such that an average of m/(m+n)×100(%) is 20% or greater,
(R¹—)P(O)(OH)₂ (1)
(R²—O—)ₐP(O)(OH)₃₋ₐ (2)
in Formulae (1) and (2), R¹ and R² each independently represent a hydrocarbon group having 14 or more carbon atoms which may be substituted with a substituent, and a represents 1 or 2,
R³(OC₂H₄)ₘ—(OC₃H₆)ₙ—NH₂ (3)
in Formula (3), R³ represents a hydrogen atom or an alkyl group having 4 or less carbon atoms, m represents an integer of 1 or greater, n represents an integer of 0 or greater, and m+n is an integer of 10 or greater, where an arrangement order of an oxyethylene unit (OC₂H₄) and an oxypropylene unit (OC₃H₆) is optional.

2. The ink jet ink composition according to claim 1,
wherein a content of the compound represented by Formula (3) is 20% by mass or greater and 80% by mass or less with respect to 100% by mass of a total mass of the metal particle.

3. The ink jet ink composition according to claim 1,
wherein the metal pigment has a volume average particle diameter D50 of 0.5 μm or less.

4. The ink jet ink composition according to claim 1,
wherein the metal pigment has a scaly shape and an average thickness of 30 nm or less.

5. The ink jet ink composition according to claim 1,
wherein a content of an organic solvent having an SP value of 26 MPau^{1/2} or less is 90% by mass or greater with respect to 100% by mass of a total mass of the organic solvent.

6. The ink jet ink composition according to claim 1,
wherein the organic solvent is selected from a glycol ether-based organic solvent and a lactone-based organic solvent.

7. The ink jet ink composition according to claim 1,
wherein a content of the organic solvent is 50% by mass or greater with respect to a total amount of the ink jet ink composition.

8. The ink jet ink composition according to claim 1,
wherein R¹ and R² represent an unsubstituted hydrocarbon group.

9. The ink jet ink composition according to claim 1,
wherein R¹ and R² represent a hydrocarbon group having 15 or more and 30 or less carbon atoms.

10. The ink jet ink composition according to claim 1,
wherein the metal particle consists of aluminum or an aluminum alloy.

11. A recording method comprising:
making the ink jet ink composition according to claim 1 adhere to a recording medium.
